(19) United States
(12) Patent Application Publication
(10) Pub. No.: US 2017/0264387 A1
(43) Pub. Date: Sep. 14, 2017

(54) ETHERNET PASSIVE OPTICAL NETWORK SORTING FRAME SEQUENCE

(71) Applicant: ELECTRONICS AND TELECOMMUNICATIONS RESEARCH INSTIT, Daejeon (KR)

(72) Inventors: Kyeong Hwan DOO, Daejeon (KR); Han Hyub LEE, Daejeon (KR); Hwan Seok CHUNG, Daejeon (KR)

(21) Appl. No.: 15/398,879

(22) Filed: Jan. 5, 2017

(30) Foreign Application Priority Data
Mar. 8, 2016 (KR) 10-2016-0027632

(51) Int. Cl. H04J 14/02; H04Q 11/00; H04B 10/27

(52) U.S. Cl. CPC H04J 14/0227; H04B 10/27; H04Q 11/0066

(57) ABSTRACT

An optical line terminal (OLT) of an Ethernet passive optical network (EPON) and an optical network unit (ONU) of the EPON. The OLT includes a frame allocator configured to allocate a plurality of frames to each of a plurality of wavelengths, and a frame outputter configured to output the frames through the wavelengths, in which each of the frames includes a frame sequence number corresponding to a sequence order of each frame. The ONU includes a frame receiver configured to receive a plurality of frames each including a frame sequence number and a frame arranger configured to arrange the frames in order based on the frame sequence number.

### CROSS-REFERENCE TO RELATED APPLICATION(S)

This application claims the priority benefit of Korean Patent Application No. 10-2016-0027632, filed on Mar. 8, 2016, in the Korean Intellectual Property Office, the disclosure of which is incorporated herein by reference for all purposes.

### BACKGROUND

1. Field

One or more example embodiments relate to an Ethernet passive optical network (EPON), and more particularly, to an EPON that may transmit a frame using a wavelength-division multiplexing (WDM) method in addition to a time-division multiplexing (TDM) method.

2. Description of Related Art

An Ethernet passive optical network (EPON) refers to a passive optical network (PON) that may communicate using an Ethernet frame structure. The EPON may be configured as a 1:N structure in which at least one optical network unit (ONU) is connected to one optical line terminal (OLT). The EPON is standardized by the Institute of Electrical and Electronics Engineers (IEEE) 802.3. Standardizations of a 1 gigabit per second (Gb/s) EPON (1 G-EPON) and a 10 G-EPON were completed in 2004 (IEEE 802.3ah) and 2010 (IEEE 802.3av), respectively. Currently, standardization of a 25 G to 100 G next generation EPON (NG-EPON) is underway. The NG-EPON may need to coexist with a device based on the existing 1 G-EPON or 10 G-EPON.

An ONU and an OLT provided in such an existing EPON may use only a single wavelength, and transmit a frame using time-division multiplexing (TDM). An increase in a transmission rate per wavelength may be restricted by chromatic dispersion and power dispersion of an optical fiber. Thus, to increase a transmission rate for transmitting a frame in the NG-EPON, research into a hybrid PON to which wavelength-division multiplexing (WDM) is applied is being conducted.

### SUMMARY

An aspect of the present disclosure provides an Ethernet passive optical network (EPON) that may coexist with an existing optical line terminal (OLT) and optical network unit (ONU), and also use a plurality of wavelengths more effectively.

According to an aspect, there is provided an OLT of an EPON, the OLT including a frame allocator configured to allocate a plurality of frames to each of a plurality of wavelengths, and a frame outputter configured to output the frames through the wavelengths. Each of the frames may include a frame sequence number corresponding to a sequence order of each frame.

The frame outputter may simultaneously transmit the frames to an ONU of the EPON through the wavelengths.

Each of the frames may include a passive optical network (PON) header including an identifier (ID) assigned to the ONU of the EPON and the frame sequence number.

The frame sequence number may be set independently for each ONU of the EPON.

Each of the frames may include a field to which the frame sequence number is to be allocated, and the field to which the frame sequence number is to be allocated may include information as to whether the frame sequence number is used.

The frame allocator may allocate the frames to each of the wavelengths based on a frame length of each of the frames.

The OLT may further include a frame receiver configured to simultaneously receive the frames from an ONU of the EPON through the wavelengths, and a frame arranger configured to arrange the frames in order based on the frame sequence number included in the received frames.

The frame arranger may convert the PON header included in each of the frames to an Ethernet frame header, and the PON header may include the ID assigned to the ONU and the frame sequence number.

According to another aspect, there is provided a frame transmitting method to be performed by an OLT of an EPON, the method including allocating a plurality of frames to each of a plurality of wavelengths, and outputting the frames through the wavelengths. Each of the frames may include a frame sequence number corresponding to a sequence order of each frame.

The allocating may include allocating the frames to each of the wavelengths based on a frame length of each of the frames.

The outputting may include simultaneously transmitting the frames to an ONU of the EPON through the wavelengths.

According to still another aspect, there is provided an ONU of an EPON, the ONU including a frame receiver configured to receive a plurality of frames each including a frame sequence number through a plurality of wavelengths, and a frame arranger configured to arrange the frames in order based on the frame sequence number.

The frame receiver may receive only a frame including an ID assigned to the ONU among the frames.

Each of the frames may include a PON header including the ID assigned to the ONU and the frame sequence number.

The frame arranger may convert the PON header included in each of the frames to an Ethernet frame header.

According to yet another aspect, there is provided a frame processing method to be performed by an ONU of an EPON, the method including receiving a plurality of frames each including a frame sequence number through a plurality of wavelengths, and arranging the frames in order based on the frame sequence number.

The receiving may include receiving only a frame including an ID assigned to the ONU among the frames.

The arranging may include converting a PON header included in each of the frames to an Ethernet frame header, and the PON header may include the ID assigned to the ONU and the frame sequence number.

According to further another aspect, there is provided an EPON including an ONU configured to receive a plurality of frames through a plurality of wavelengths and an OLT configured to output the frames to at least one ONU through the wavelengths. Each of the frames may correspond to a frame sequence order, and include a frame sequence number independently set for each ONU.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which: FIG. 1 is a diagram illustrating a structure of an Ethernet passive optical network (EPON) according to an example embodiment;

FIG. 2 is a diagram illustrating a structure of an optical line terminal (OLT) according to an example embodiment;

FIG. 3 is a diagram illustrating a structure of an optical network unit (ONU) according to an example embodiment;

FIG. 4 is a flowchart illustrating a method of transmitting, by an OLT, a plurality of frames according to an example embodiment; and

FIG. 5 is a flowchart illustrating a method of arranging, by an ONU, a plurality of received frames according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

Various alterations and modifications may be made to the examples. Here, the examples are not construed as limited to the disclosure and should be understood to include all changes, equivalents, and replacements within the idea and the technical scope of the disclosure.

Terms such as first, second, A, B, (a), (b), and the like may be used herein to describe components. Each of these terminologies is not used to define an essence, order or sequence of a corresponding component but used merely to distinguish the corresponding component from other component(s). For example, a first component may be referred to a second component, and similarly the second component may also be referred to as the first component.

It should be noted that if it is described in the specification that one component is “connected,” “coupled,” or “joined” to another component, a third component may be “connected,” “coupled,” and “joined” between the first and second components, although the first component may be directly connected, coupled or joined to the second component. In addition, it should be noted that if it is described in the specification that one component is “directly connected” or “directly joined” to another component, a third component may not be present therebetween. Likewise, expressions, for example, “between” and “immediately between” and “adjacent to” and “immediately adjacent to” may also be construed as described in the foregoing.

The terminology used herein is for the purpose of describing particular embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Example embodiments to be described hereinafter may be supported by standard documents disclosed in Institute of Electrical and Electronics Engineers (IEEE) 802.3. Stages or operations, or parts, in the example embodiments that are not described to explicitly disclose technical features of the present disclosure may be supported by the standard documents. In addition, all terms used in the present disclosure may be explained by the standard documents. Although the example embodiments are described focusing on an IEEE 802.3 system for clarity, the technical features of the present disclosure may not be limited to the system.

Hereinafter, examples are described in detail with reference to the accompanying drawings. Like reference numerals in the drawings denote like elements, and a known function or configuration will be omitted herein.

FIG. 1 is a diagram illustrating a structure of an Ethernet passive optical network (EPON) according to an example embodiment.

Referring to FIG. 1, the EPON includes an optical line terminal (OLT) 110 and at least one optical network unit (ONU). For convenience of description, it is assumed that two ONUs, for example, a first ONU 120 and a second ONU 130, are connected to the OLT 110.

The OLT 110 may transmit a plurality of frames to the at least one ONU through a plurality of wavelengths. A graph 111 indicates the frames output by the OLT 110 that are classified based on a time, a wavelength, and an ONU. Referring to the graph 111, the OLT 110 may transmit the frames using four different wavelength bands, for example, λ1, λ2, λ3, and λ4. In addition, the OLT 110 may change a wavelength band allocated to each ONU based on a time. The changing of a wavelength band allocated to each ONU may be performed by an ONU in addition to the OLT 110.

In the graph 111, a frame to be transmitted from the OLT 110 to the first ONU 120 is indicated by a number on a white background, and a frame to be transmitted from the OLT 110 to the second ONU 130 is indicated by a number on a black background. Although it is assumed that sizes of the frames are equal in the graph 111, sizes of frames of the EPON may be different from one another.

In FIG. 1, a number indicated for a frame is a sequence order of the frame. Hereinafter, it is assumed that the OLT 110 transmits data to the first ONU 120 by dividing the data into 12 frames, and transmits data to the second ONU 130 by dividing the data into 8 frames. Each frame may include a frame sequence number corresponding to a sequence order of each frame. The frame sequence number may be set independently for each ONU.

The OLT 110 may allocate, to a plurality of wavelength bands, a plurality of frames to be transmitted to a certain ONU. Thus, the OLT 110 may simultaneously transmit the frames to the ONU. Referring to the graph 111, a first frame and a second frame to be transmitted to the first ONU 120 may be allocated to different wavelength bands, for example, λ3 and λ4, and thus the frames may be simultaneously transmitted to the first ONU 120 in a time section t1. In addition, the OLT 110 may allocate a single wavelength band to a certain ONU. Referring to the graph 111, the OLT 110 may allocate only a single wavelength band, for example, λ3, to the second ONU 130 in a time section t2. That is, the OLT 110 may change a wavelength band and a number of wavelength bands allocated to each ONU in each time section.

According to an example embodiment, an optical signal output from the OLT 110 may be transmitted to a plurality of ONUs through a single optical fiber. The EPON may include an optical splitter 140 to distribute, to the ONUs, the optical signal to be transmitted along the optical fiber. An optical signal received by the first ONU 120 may include a frame to be transmitted from the OLT 110 to the first ONU 120 and also a frame to be transmitted from the OLT 110 to the second ONU 130.

The first ONU 120 and the second ONU 130 may receive the frames transmitted from the OLT 110 through the wavelengths. The first ONU 120 and the second ONU 130 may receive the frames through the four different wavelength bands λ1 through λ4. That is, when the OLT 110 transmits the frames to the first ONU 120 and the second ONU 130 as indicated in the graph 111, the first ONU 120 and the second ONU 130 may receive the frames based on a time as indicated in the graph 111.

The OLT 110 may assign, to each ONU, an identifier (ID) that is used to identify each ONU, while an ONU is subscribing to a network. For example, the OLT 110 may assign, to each ONU, a logical link identifier (LLID) based on an IEEE 802.3 standard. By inserting such an ID in a frame, the OLT 110 may indicate, in the frame, a target ONU of the frame.

An ONU may receive only a frame including an ID assigned to the ONU among a plurality of frames received by the ONU. In detail, as illustrated in FIG. 1, the first ONU 120 and the second ONU 130 may extract only frames including respective LLIDs of the first ONU 120 and the second ONU 130 from the received frames as indicated in the graph 111. The second ONU 130 may receive only the frames indicated by the numbers on the black background by comparing an LLID of the second ONU 130 to an LLID indicated in a frame. The first ONU 120 may also receive only the frames indicated by the numbers on the white background by comparing an LLID of the first ONU 120 to an LLID indicated in a frame.

An ONU may arrange received frames in order. The ONU may identify a frame sequence number included in each of the received frames. Further, the ONU may arrange the frames in order based on the frame sequence number included in each of the frames.

Referring to FIG. 1, the second ONU 130 may simultaneously receive a fifth frame, a sixth frame, and a seventh frame in a time section t4. That is, the second ONU 130 may identify a frame sequence number included in each of the fifth frame, the sixth frame, and the seventh frame. The second ONU 130 may identify a sequence order of each of the fifth frame, the sixth frame, and the seventh frame that are simultaneously received. The second ONU 130 may identify a sequence order of each frame by identifying a frame sequence number of each of remaining frames.

The second ONU 130 may generate a result frame 131 by arranging the frames based on the identified sequence order. Similarly, the first ONU 120 may perform such an arrangement and generate a result frame 121. The first ONU 120 and the second ONU 130 may generate the result frame 121 and the result frame 131, respectively, in a reconciliation sublayer (RS). Thus, although an upper layer does not support a frame sequence arrangement, the frames that are transmitted from the OLT 110 may be arranged.

The number of wavelength bands and a change in wavelength band that are illustrated in the graph 111 are provided as a mere example for convenience of description, and thus the number of wavelength bands of the EPON and a pattern that changes a wavelength band are not limited to the example illustrated in the graph 111 and FIG. 1. In addition, although only an example of a transmission of frames from the OLT 110 to the first ONU 120 and the second ONU 130 is described, the first ONU 120 and the second ONU 130 may also transmit a plurality of frames each including a frame sequence number to the OLT 110. In such a case, the OLT 110 may arrange the frames for each of the first ONU 120 and the second ONU 130 based on the frame sequence number and an LLID.

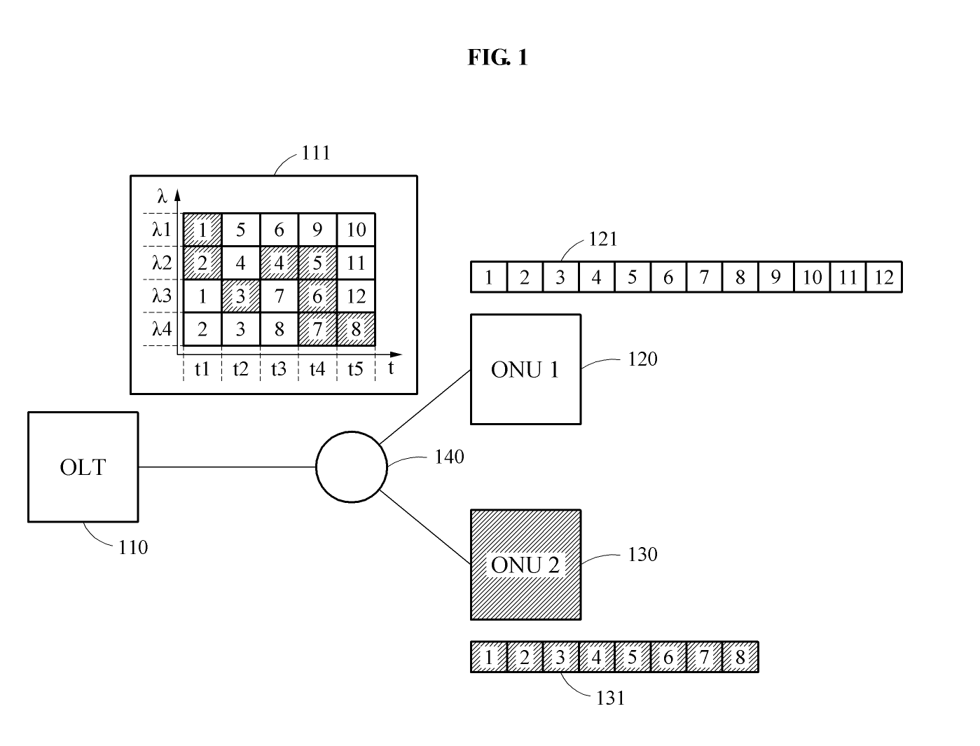

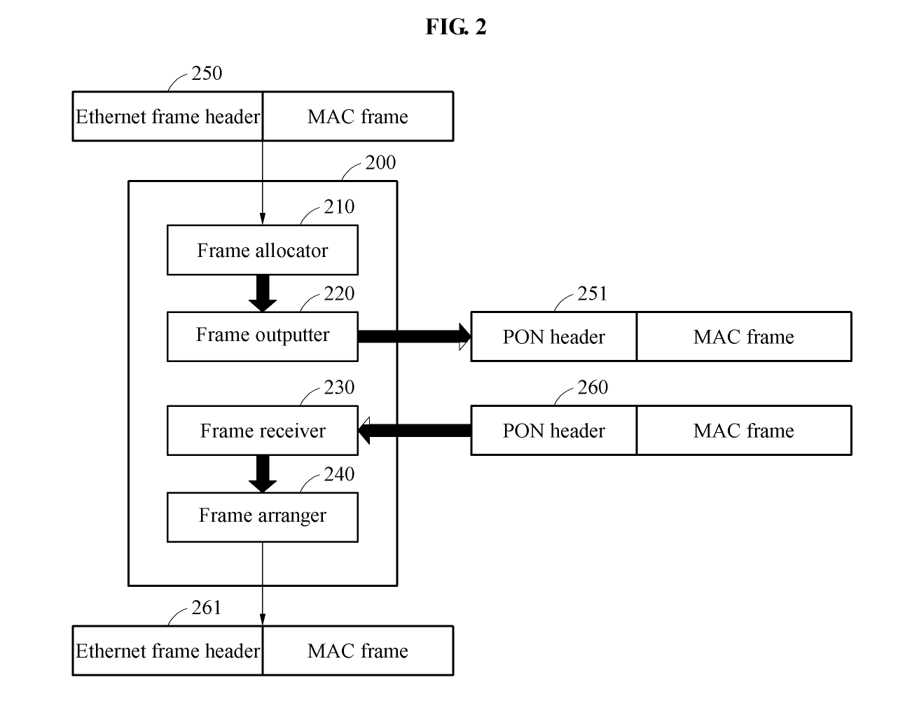

FIG. 2 is a diagram illustrating a structure of an OLT 200 according to an example embodiment.

Referring to FIG. 2, the OLT 200 includes a frame allocator 210 configured to allocate a plurality of frames to each of a plurality of wavelengths, and a frame outputter 220 configured to output the frames through the wavelengths. The OLT 200 further includes a frame receiver 230 configured to simultaneously receive the frames from an ONU through the wavelengths, and a frame arranger 240 configured to arrange the frames in order based on a frame sequence number included in each of the received frames.

The OLT 200 may receive an initial transmission Ethernet frame 250 including data to be transmitted to the ONU. The initial transmission Ethernet frame 250 may be classified into an Ethernet frame header and a media access control (MAC) frame. The Ethernet frame header may include a preamble and a starting frame delimiter (SFD) as illustrated in Table 1 below, and the MAC frame may include a destination address (DA) field, a source address (SA) field, a length/type field, a data/padding (PAD) field, and a frame check sequence (FCS) as illustrated in Table 2 below.

TABLE 1

| Field | Octets |
|---|---|
| Preamble | 7 |
| Starting Frame Delimiter (SFD) | 1 |

TABLE 2

| Field | Octets |
|---|---|
| Destination Address (DA) | 6 |
| Source Address (SA) | 6 |
| Length/Type | 2 |
| Data/PAD | 46 to 1504 |
| Frame Check Sequence (FCS) | 4 |

Referring to Table 2, since a length of the data/PAD field is not fixed, lengths of a plurality of initial transmission Ethernet frames 250 to be received by the OLT 200 may be different.

Referring to FIG. 2, the frame allocator 210 may allocate the initial transmission Ethernet frames 250 to each of the wavelengths. When the lengths of the initial transmission Ethernet frames 250 are different, the frame allocator 210 may allocate the initial transmission Ethernet frames 250 to each of the wavelengths based on the lengths of the initial transmission Ethernet frames 250. The frame allocator 210 may allocate, to the wavelengths, the initial transmission Ethernet frames 250 to be transmitted. In such a case, the OLT 200 may simultaneously transmit the initial transmission Ethernet frames 250 to the wavelengths. Thus, the OLT 200 may use a wavelength band more effectively.

Further, the frame allocator 210 may allocate, to each frame, a frame sequence number corresponding to a sequence order of each frame. The frame sequence number may be independently set for each ONU. An ONU may arrange received frames in order based on a frame sequence number of each of the frames. Thus, the OLT 200 may transmit the frames without considering a time sequence and a sequence of wavelength bands. Thus, availability of a wavelength band may increase.

Referring to FIG. 2, the frame outputter 220 may output the frames through the wavelengths based on a result of the allocation performed by the frame allocator 210. The frame outputter 220 may include a device configured to multiplex an optical signal in order to use the wavelengths.

The frame outputter 220 may output a final transmission Ethernet frame 251 by converting the Ethernet frame header of the initial transmission Ethernet frame 250 to a PON header. That is, the OLT 200 may transmit the final transmission Ethernet frame 251, which may be at least one final transmission Ethernet frame, to an ONU. Referring to a length of the MAC frame illustrated in Table 2 above, a length of the final transmission Ethernet frame 251 may be 64 bytes to 1518 bytes.

The PON header may include an ID assigned to the ONU and a frame sequence number. In detail, the PON header may include the following fields as illustrated in Table 3 below according to an IEEE 802.3 standard.

TABLE 3

| Field | Octets |
|---|---|
| Reserved | 2 |
| Start of LLID Delimiter (SLD) | 1 |
| Reserved | 1 |
| Frame Sequence Number | 1 |
| LLID | 2 |
| Cyclic Redundancy Check (CRC) | 1 |

Referring to Table 3, an LLID of the ONU, which is a target receiving the final transmission Ethernet frame 251, may be recorded in an LLID field of the PON header. A frame sequence number corresponding to a sequence order of the final transmission Ethernet frame 251 may be recorded in a frame sequence number field of the PON header. Since the final transmission Ethernet frame 251 includes, in the LLID field, information used to identify an ONU, a frame sequence number may be independently set for each ONU.

The frame sequence number field may use 1 byte of a reserved field in the IEEE 802.3 standard. Thus, the final transmission Ethernet frame 251 may not affect an operation of an existing OLT and ONU. Thus, an OLT and ONU according to an example embodiment of the present disclosure may coexist with a device according to an existing 1 G-EPON or 10 G-EPON.

A size of the frame sequence number field in the PON header may be set to be values other than 1 byte. According to the IEEE 802.3 standard, a size of the reserved field in the PON header may be 4 bytes. Thus, the size of the frame sequence number field may be set to be up to 4 bytes based on the coexistence with the existing EPON device.

According to an example embodiment, an OLT or ONU may adjust a frame arrangement based on a situation. For example, when the OLT needs to allocate only a single wavelength to each ONU, the OLT may transmit frames in order without assigning a frame sequence number to each of the frames.

Referring to FIG. 2, the OLT 200 may indicate, in the frame sequence number field of the final transmission Ethernet frame 251, information as to whether the frame sequence number is used. In detail, the OLT 200 may use a certain bit in the frame sequence number field, or indicate whether the frame sequence number is used based on whether the frame sequence number is greater than or less than a certain number. An ONU may identify a transmission method used by the OLT 200 based on whether the frame sequence number is used, and further determine whether to arrange received frames in order.

The OLT 200 may receive an initial reception Ethernet frame 260 from an ONU. The initial reception Ethernet frame 260 may include a PON header and a MAC frame. The frame receiver 230 may identify the ONU that transmits the initial reception Ethernet frame 260 based on an LLID field of the PON header. The frame receiver 230 may identify a sequence order of the initial reception Ethernet frame 260 based on a frame sequence number field of the PON header.

In addition, since the frame receiver 230 receives an optical signal multiplexed to the wavelengths, the frame receiver 230 may include a device configured to demultiplex the multiplexed optical signal.

The frame arranger 240 may arrange, in order, a plurality of initial reception Ethernet frames 260. Here, a plurality of ONUs may be connected to the OLT 200. Thus, the frame arranger 240 may classify the initial reception Ethernet frames 260 for each ONU, and arrange the initial reception Ethernet frames 260 in order for each ONU.

The frame arranger 240 may generate a final reception Ethernet frame 261 by converting the PON header of the initial reception Ethernet frame 260 to an Ethernet frame. The frame arranger 240 may then output a plurality of final reception Ethernet frames 261 that is arranged in order.

Here, the conversion between the PON header and the Ethernet frame header may be performed in an RS of the OLT 200. Thus, although a layer upper than the RS does not support a frame sequence arrangement, the OLT 200 may arrange frames in order.

According to an example embodiment, an ONU may also perform the transmission and arrangement performed by the OLT 200 on the frames. The ONU may perform the arrangement only on a plurality of frames associated with the ONU. The ONU may distribute the frames to a time section and a plurality of wavelengths allocated to the ONU to transmit the frames to the OLT 200 through the wavelengths.

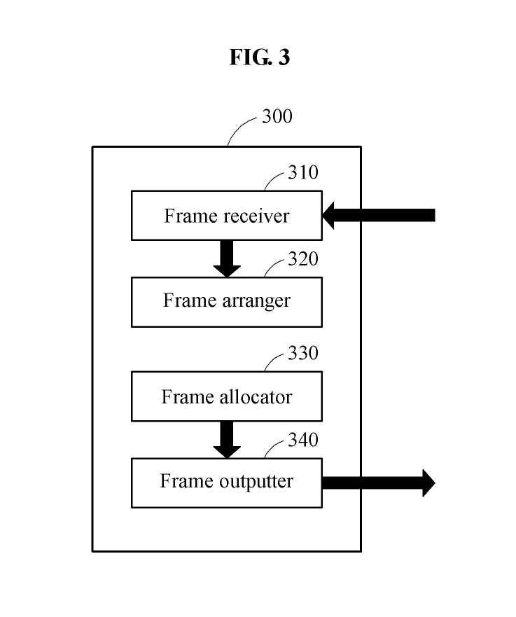

FIG. 3 is a diagram illustrating a structure of an ONU 300 according to an example embodiment. A description of an operation of the ONU 300 that is similar to the operations of the OLT 200 described with reference to FIG. 2 will be omitted.

Referring to FIG. 3, the ONU 300 includes a frame receiver 310 configured to receive a plurality of frames each including a frame sequence number through a plurality of wavelengths, and a frame arranger 320 configured to arrange the frames in order based on the frame sequence number.

The frame receiver 310 may extract, from the frames, only a frame corresponding to the ONU 300 based on a PON header of the frames. In detail, the ONU 300 may extract only a frame in which an LLID of the ONU 300 is recorded in an LLID field of the PON header.

The frame arranger 320 may arrange the extracted frames in order based on the frame sequence number included in the PON header. Further, the frame arranger 320 may output the extracted frames in order based on a sequence order of each of the frames.

The frame arranger 320 may convert the PON header to an Ethernet frame header to allow the frames to be used in an upper layer. When the arrangement is completed by the frame arranger 320, the frame sequence number included in the PON header may become unnecessary information. Thus, the frame arranger 320 may remove the unnecessary frame sequence number by converting the PON header to the Ethernet frame header.

The ONU 300 may transmit, to an OLT through the wavelengths, the frames that are to be transmitted to the OLT. In detail, a frame allocator 330 may allocate the frames to be transmitted to the wavelengths. The frame allocator 330 may allocate the frames to the wavelengths based on a wavelength band allocated by the OLT.

A frame outputter 340 may transmit the frames to the OLT through the wavelengths based on a result of the allocation performed by the frame allocator 330. The OLT may allocate a wavelength band for each ONU in each time section, and the frame outputter 340 may transmit the frames based on the allocation. Thus, the ONU 300, which may be a plurality of ONUs, may transmit a frame using a single optical fiber.

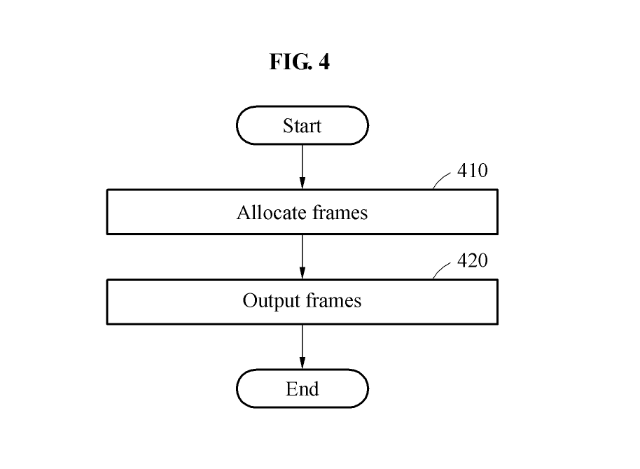

FIG. 4 is a flowchart illustrating a method of transmitting, by an OLT, a plurality of frames according to an example embodiment.

Referring to FIG. 4, in operation 410, the OLT allocates each of frames to one of wavelengths. When the OLT transmits a plurality of frames to a certain ONU, the OLT may allocate the frames to a plurality of wavelengths. The OLT may provide the ONU with a sequence order of each of the frames to be transmitted simultaneously by assigning a frame sequence number corresponding to the sequence order of each of the frames. The OLT may allocate the frames to the wavelengths based on a length of each of the frames.

In operation 420, the OLT outputs the frames through the wavelengths by multiplexing each of the frames to the wavelengths. That is, the frames may be multiplexed to be a single optical signal through the wavelengths. The multiplexed optical signal may be transmitted to at least one ONU. When a plurality of frames to be transmitted to a certain ONU is allocated to a plurality of wavelengths in operation 410, the frames may be simultaneously transmitted to the ONU.

In operation 420, the OLT indicates, in each of the frames, the frame sequence number allocated in operation 410. In addition, the OLT indicates, in a frame, an ID assigned to an ONU that is to receive the frame. In detail, the OLT may convert an Ethernet frame header included in the frames to a PON header defined in Table 3.

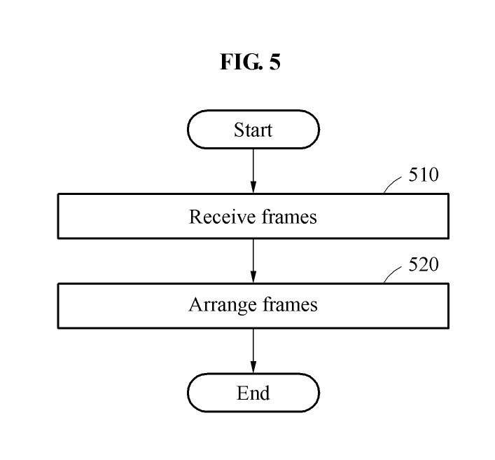

FIG. 5 is a flowchart illustrating a method of arranging, by an ONU, a plurality of received frames according to an example embodiment.

Referring to FIG. 5, in operation 510, the ONU receives a plurality of frames through a plurality of wavelengths. Each of the received frames may include a frame sequence number. The ONU may receive only a frame including an ID assigned to the ONU.

In operation 520, the ONU arranges the frames in order based on the frame sequence number. The ONU may identify the frame sequence number included in a PON header of each of the frames. The ONU may then output a frame corresponding to the frame sequence number to arrange the frames. The ONU may output the frames by converting the PON header of each of the frames to an Ethernet frame header.

The components described in the exemplary embodiments of the present invention may be achieved by hardware components including at least one DSP (Digital Signal Processor), a processor, a controller, an ASIC (Application Specific Integrated Circuit), a programmable logic element such as an FPGA (Field Programmable Gate Array), other electronic devices, and combinations thereof. At least some of the functions or the processes described in the exemplary embodiments of the present invention may be achieved by software, and the software may be recorded on a recording medium. The components, the functions, and the processes described in the exemplary embodiments of the present invention may be achieved by a combination of hardware and software.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processor.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical line terminal (OLT) of an Ethernet passive optical network (EPON), the OLT comprising:
a frame allocator configured to allocate a plurality of frames to each of a plurality of wavelengths; and
a frame outputter configured to output the frames through the wavelengths,
wherein each of the frames includes a frame sequence number corresponding to a sequence order of each frame.

2. The OLT of claim 1, wherein the frame outputter is configured to simultaneously transmit the frames to an optical network unit (ONU) of the EPON through the wavelengths.

3. The OLT of claim 1, wherein each of the frames includes a passive optical network (PON) header including an identifier (ID) assigned to an ONU of the EPON and the frame sequence number.

4. The OLT of claim 1, wherein the frame sequence number is set independently for each ONU of the EPON.

5. The OLT of claim 1, wherein each of the frames includes a field to which the frame sequence number is to be allocated,
wherein the field to which the frame sequence number is to be allocated includes information as to whether the frame sequence number is used.

6. The OLT of claim 1, wherein the frame allocator is configured to allocate the frames to each of the wavelengths based on a frame length of each of the frames.

7. The OLT of claim 1, further comprising:
a frame receiver configured to simultaneously receive, from an ONU of the EPON, the frames through the wavelengths; and
a frame arranger configured to arrange the frames in order based on respective frame sequence numbers included in the received frames.

8. The OLT of claim 7, wherein the frame arranger is configured to convert a PON header included in each of the frames to an Ethernet frame header, and
the PON header includes an ID assigned to the ONU and the frame sequence number.

9. A frame transmitting method to be performed by an optical line terminal (OLT) of an Ethernet passive optical network (EPON), the method comprising:
allocating a plurality of frames to each of a plurality of wavelengths; and
outputting the frames through the wavelengths,
wherein each of the frames includes a frame sequence number corresponding to a sequence order of each frame.

10. The frame transmitting method of claim 9, wherein the allocating comprises:
allocating the frames to each of the wavelengths based on a frame length of each of the frames.

11. The frame transmitting method of claim 9, wherein the outputting comprises:
simultaneously transmitting the frames to an optical network unit (ONU) of the EPON through the wavelengths.

12. An optical network unit (ONU) of an Ethernet passive optical network (EPON), the ONU comprising:
a frame receiver configured to receive a plurality of frames each including a frame sequence number through a plurality of wavelengths; and
a frame arranger configured to arrange the frames in order based on the frame sequence number.

13. The ONU of claim 12, wherein the frame receiver is configured to receive only a frame including an identifier (ID) assigned to the ONU among the frames.

14. The ONU of claim 12, wherein each of the frames comprises a passive optical network (PON) header including an ID assigned to the ONU and the frame sequence number.

15. The ONU of claim 12, wherein the frame arranger is configured to convert a PON header included in each of the frames to an Ethernet frame header.
